(19) United States
(12) Patent Application Publication
(10) Pub. No.: US 2025/0270726 A1
(43) Pub. Date: Aug. 28, 2025

(54) LIDAR-VISIBLE COATING SYSTEM

(71) Applicant: SWIMC LLC, Cleveland, OH (US)

(72) Inventor: Dehui HAN, Solon, OH (US)

(21) Appl. No.: 18/858,061

(22) PCT Filed: Apr. 18, 2023
(86) PCT No.: PCT/US2023/065892

§ 371 Date: Oct. 18, 2024

Related U.S. Application Data
(60) Provisional application No. 63/332,287, filed on Apr. 19, 2022.

(51) Int. Cl. C25D 5/00

(52) U.S. Cl. CPC C25D 5/627

(57) ABSTRACT

The present application relates to a LiDAR-visible coating system comprising at least one converter layer and at least one NIR transmitting layer at least partially coating the at least one converter layer, wherein the converter layer at least partially coated by the NIR transmitting layer has an L* value ranging from 0 to 80 according to the CIELAB L*a*b* system. In many embodiments, at least one converter layer is an NIR reflective layer. The coating system described herein may be detectable by a LiDAR sensor at various wavelengths, including 905 nm and 1550 nm. A method of preparing the coating system and an article with the coating system are also disclosed.

### FIELD

The present disclosure relates generally to a coating system comprising: at least one converter layer and at least one NIR transmitting layer at least partially coating the at least one converter layer, wherein the converter layer at least partially coated by the NIR transmitting layer has an L* value ranging from 0 to 80 according to the CIELAB L*a*b* system. In many embodiments, at least one converter layer is an NIR reflective layer, allowing that converter layer to be LiDAR-visible. The coating system described herein may be detectable by a LiDAR sensor at various wavelengths. A method of preparing the coating system and an article containing the coating system are also disclosed.

### BACKGROUND

More recently, both advanced driver assistance systems (ADAS) and autonomous driving (AD) have been used to successfully navigate vehicles using sensing technologies. These sensing technologies may include: 1) image sensors, 2) radar, and 3) LiDAR (Light Detection and Ranging). Although each sensing technology has strengths and weaknesses, there has been substantial growth for LiDAR technology and it is expected to grow further. Additionally, these LiDAR may be used for other applications besides the automotive industry, including but not limited to aerospace, remote sensing measuring (for example, vegetation growth, digital elevation and topography modeling), crop mapping, environmental analysis, law enforcement, transportation and infrastructure, medical imaging, and the entertainment industry.

LiDAR emits near-infrared (NIR) laser pulses and then detects NIR light reflected by surrounding objects. NIR is the section of electromagnetic radiation (EMR) wavelengths nearest to the normal range but just past what we can see in the visible spectrum. NIR wavelengths are typically in the range of 800 nm to 2500 nm. LiDAR's use of light allows it to map an environment both more quickly and accurately than other systems that use sound (like sonar) or microwaves (like radar). For vehicles, LiDAR sensors used to recognize surrounding objects may detect an exterior coating system applied to objects such as vehicles, road signs, traffic cones, buildings, barriers, and curbs. Typically, an object is “LiDAR visible” if it is NIR reflective. An object may be NIR reflective if it was within the light spectrum just outside of the visible (wavelength of 400-700 nm), usually 700 nm to 2050 nm, and specifically 905 nm and 1550 nm for standardized LiDAR wavelengths. However, wavelengths as low as 290 nm and as high as 2500 nm may potentially be LiDAR visible. When an object is LiDAR visible, there is a higher navigation accuracy for the vehicle.

For LiDAR, both performance specifications and reliable detection of low-reflectivity objects are necessary. However, LiDAR may struggle to detect both low-reflectivity and non NIR-reflective objects. These objects may include certain substrates such as plastics, composites, concrete, cement, wood, and masonry, making them untrustworthy for LiDAR sensing and potentially dangerous. Further, LiDAR may also have difficulty in detecting darker colors, especially without a white or light colored primer or basecoat, because of the low-reflectivity or non-NIR-reflectivity.

Manufacturers and consumers are continually looking for coatings and coatings systems that exhibit these improved properties, such as improved LiDAR visibility without sacrificing other performance properties and color options. In view of these challenges with many conventional LiDAR coatings, the need therefore remains for improved LiDAR coatings that provide a LiDAR-visible coating over a low-reflectivity or a non NIR-reflective substrate that can provide wear resistance, adhesion, weather resistance, gloss retention, and other improved properties as well as other advantages.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

A coating system and methods of preparing are shown and described. The coating system is a LiDAR-visible coating system comprising at least one converter layer and at least one NIR transmitting layer at least partially coating the at least one converter layer, wherein the converter layer at least partially coated by the NIR transmitting layer has an L* value ranging from 0 to 80 according to the CIELAB L*a*b* system. In many embodiments, at least one converter layer is an NIR reflective layer. The coating system described herein may be detectable by a LiDAR sensor at various wavelengths, including 905 nm and 1550 nm.

A method of preparing the LiDAR-visible coating system is disclosed herein. An article with the LiDAR-visible coating system is also disclosed.

To the accomplishment of the foregoing and related ends, the following description set forth certain illustrative aspects and implementations. These are indicative of a few of the various ways in which one or more aspects may be employed. Other aspects, advantages and novel features of the disclosure will become apparent from the following detailed description when considered.

### BRIEF DESCRIPTION OF THE DRAWINGS

These and other features, aspects and advantages are better understood when the following detailed description is read with reference to the accompanying drawings, in which:

FIG. 1 is a schematic illustration showing a traditional LiDAR coatings system in accordance with what is currently known in the art.

FIG. 2 is a schematic illustration showing a coatings system in accordance with aspects described herein.

FIG. 3 is a schematic illustration showing a coatings system in accordance with aspects described herein

FIG. 4 is a schematic illustration showing a coatings system in accordance with aspects described herein.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

### Substitute Sheet (Rule 26)

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

Currently, LiDAR is used as a primary sensor for self-driving or autonomous vehicles and other objects to navigate surroundings in real-time. LiDAR emits near-infrared (NIR) laser pulses and then detects NIR light reflected by these surrounding objects. Specifically, a coating is “LiDAR visible” if LiDAR sensors used to recognize surrounding objects may detect a coating or coating system applied to objects, typically within the light spectrum just outside of the visible (wavelength of 400-700 nm), usually 700 nm to 2500 nm or 800 nm to 2500 nm, and specifically 905 nm to 1550 nm for standardized LiDAR wavelengths. FIG. 1 provides a traditional LiDAR coatings system 100 used in the industry with the basecoat 120 being the predominant color seen by a viewer. With this traditional LiDAR coatings system 100, a light reflective layer 110 is provided in order for detection of the NIR light reflected by the NIR laser pulses. Typically, this light reflective layer 110 is white or light-colored in order to be LiDAR detectible. Specifically, the color of this light reflective layer 110 that is white or light-colored must provide a value measurement (also referred to as the dimension of lightness/darkness) describing the overall intensity or strength of the light having an L* value typically ranging from 80 to 100 according to the CIELAB L*a*b* system for measurement. Although this type of technology has been used, it is difficult to provide darker colored coatings with a high jetness due to the white or light-colored light reflective layer (as used as a primer) underneath the basecoat. Further, color matching is increasingly difficult due to the contrast between the basecoat 120 and light reflective layer 110, especially when darker colors are needed.

The present disclosure relates generally to coatings that provide advantageous improvements over current coatings. It has been discovered that the use of a particular coating system comprising at least one converter layer and at least one NIR transmitting layer at least partially coating the at least one converter layer, wherein the converter layer at least partially coated by the NIR transmitting layer having an L* value ranging from 0 to 80 according to the CIELAB L*a*b* system can surprisingly lead to improved performance properties when used in a coating, namely wear resistance, adhesion, weather resistance, gloss retention, and other improved properties as well as other advantages.

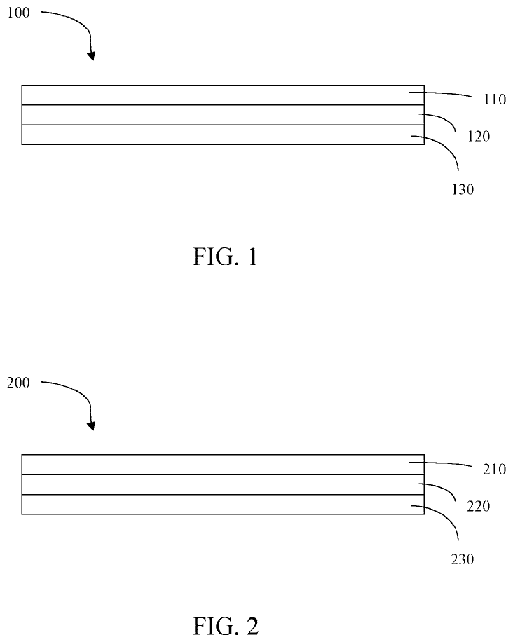

In many embodiments, a coating system 200 disclosed in FIG. 2 comprises: 1) at least one converter layer 230 and 2) at least one NIR transmitting layer 220 at least partially coating the at least one converter layer 230, wherein the converter layer at least partially coated by the NIR transmitting layer has an L* value ranging from 0 to 80 according to the CIELAB L*a*b* system. The coating system 200 described herein may be at least partially coated on a substrate (as shown in FIG. 4) to make it LiDAR-visible, including over substrates that have low-reflectivity or considered to be a non-NIR-reflective substrate such as plastics.

### NIR Reflective Layer

In many embodiments, at least one converter layer 230 is NIR reflective. This converter layer 230 is an NIR reflective layer. A NIR reflective substrate may provide light reflectance in the near-infrared wavelength range (typically 800 nm to 2500 nm). In essence, at least one converter layer 230 is applied to either: 1) a non NIR-reflective substrate to convert it to a NIR-reflective substrate or 2) a NIR-reflective substrate to maintain or improve its NIR-reflective properties. By definition, non NIR-reflective substrates are not capable of reflecting NIR light. Non NIR-reflective substrates may include but are not limited to plastic, composite, concrete, cement, masonry, wood, paper, fabrics, ceramics, composite, or combinations thereof. Other non NIR-reflective substrates are also contemplated. In some embodiments, NIR-reflective substrates may include but are not limited to metal and metal composites.

For an NIR reflective layer, light may be reflected and the absorption properties can be extracted from the reflected light (reflectance). In some embodiments, multiple converter layers may be used as long as the outermost converter layer is at least partially coated by at least one NIR transmitting layer 220. In many embodiments, at least one converter layer 230 is a primer. In other embodiments, the transmitting layer is a coating at least partially applied over a primer. In many embodiments, the dry film thickness of the converter can be between 1 mil to 4 mils (25 μm-100 μm). In many embodiments, the converter layer has a uniform coating thickness. In many embodiments, increased film thickness may provide higher reflectivity.

In many embodiments, the converter layer at least partially coated by the NIR transmitting layer has an L* value ranging from 0 to 80 according to the CIELAB L*a*b* system. In some embodiments, the L* value can, for example, range from 0 to 75, from 0 to 70, from 0 to 65, from 0 to 60, from 0 to 55, from 0 to 50, from 1 to 80, from 1 to 75, from 1 to 70, from 1 to 65, from 1 to 60, from 1 to 55, from 1 to 50, from 2 to 80, from 2 to 75, from 2 to 70, from 2 to 65, from 2 to 60, from 2 to 55, from 2 to 50, from 3 to 80, from 3 to 75, from 3 to 70, from 3 to 65, from 3 to 60, from 3 to 55, from 3 to 50, from 5 to 80, from 5 to 75, from 5 to 70, from 5 to 65, from 5 to 60, from 5 to 55, from 5 to 50, from 10 to 80, from 10 to 75, from 10 to 70, from 10 to 65, from 10 to 60, from 10 to 55, from 10 to 50, from 15 to 80, from 15 to 75, from 15 to 70, from 15 to 65, from 15 to 60, from 15 to 55, from 15 to 50, from 20 to 80, from 20 to 75, from 20 to 70, from 20 to 65, from 20 to 60, from 20 to 55, from 20 to 50, from 25 to 80, from 25 to 75, from 25 to 70, from 25 to 65, from 25 to 60, from 25 to 55, from 25 to 50, from 30 to 80, from 30 to 75, from 30 to 70, from 30 to 65, from 30 to 60, from 30 to 55, and from 30 to 50. Higher ranges are also contemplated.

In many embodiments, the NIR reflective layer comprises at least one pigment. In one embodiment, at least one pigment is an organic pigment. In another embodiment, at least one pigment is an inorganic pigment.

In some embodiments, at least one pigment of the NIR reflective layer is an organic pigment. In some embodiments, the organic pigment is perylene black, organic colorants, organic dyes, or combinations thereof. In some embodiments, the organic pigment is phthalocyanine blue, perylene black, isoindolinone yellow, Quinacridone violet, pigment red 254, perylene red, benzimidazole brown, their combinations thereof. In one embodiment, the organic pigment is a pigment dispersion. In many embodiments, the coatings system 200 may comprise 1% to 20% by weight of at least one organic pigment. In some embodiments, at least one organic pigment can, for example, range from about 1% to about 18%, from about 1% to about 15%, from about 1% to about 13%, from about 1% to about 10%, from about 1% to about 9%, from about 1% to about 10%, from about 1% to about 9%, from about 2% to 20%, from about 2% to about 18%, from about 2% to about 15%, from about 2% to about 13%, from about 2% to about 10%, from about 2% to about 9%, from about 2% to about 8%, from about 2% to about 7%, from about 2% to about 5%, from about 2% to about 4%, from about 3% to 20%, from about 3% to about 18%, from about 3% to about 15%, from about 3% to about 13%, from about 3% to about 10%, from about 3% to about 9%, from about 3% to about 8%, from about 3% to about 7%, from about 4% to about 20%, from about 4% to about 18%, from about 4% to about 15%, from about 4% to about 13%, from about 4% to about 10%, from about 4% to about 9%, from about 4% to about 8%, from about 5% to about 20%, from about 5% to about 18%, from about 5% to about 15%, from about 5% to about 13%, from about 5% to about 10%, from about 5% to about 9%, and from about 5% to about 8%. Other ranges are also contemplated.

In some embodiments, at least one pigment of the NIR reflective layer is an inorganic pigment. In some embodiments, the inorganic pigment is titanium dioxide, zinc oxide, aluminum silicate, magnesium silicate, silica, barium sulfate, calcium sulfate, zinc chromate, chromium hematite/chromium iron oxides, chromium oxide, iron oxide, copper oxide, calcium molybdate, strontium molybdate, zinc molybdate, zinc phosphate, zinc powder, copper powder, aluminum powder, zinc sulfide, cadmium sulfide, pearlized pigments, mica, metallic pigments, metallic effects pigments, china clay, Diatomaceous silica, inorganic colorants, inorganic dyes, or combinations thereof. In one embodiment, the inorganic pigment is a pigment dispersion. In another embodiment, the inorganic pigment is a paste.

In many embodiments, at least one inorganic pigment of the NIR reflective layer comprises 10% to 60% by weight of the coatings system 200. In some embodiments, at least one inorganic pigment can, for example, range from about 15% to about 60%, from about 20% to about 60%, from about 25% to about 60%, from about 30% to about 60%, from about 10% to about 50%, from about 15% to about 50%, from about 20% to about 40%, from about 25% to about 40%, from about 30% to about 50%, from about 10% to about 40%, from about 10% to about 30%, from about 10% to about 25%, from about 10% to about 20%, from about 20% to about 50%, from about 20% to about 35%, from about 20% to about 30%, from about 25% to about 50%, and from about 25% to about 45%. Other ranges are also contemplated.

At least one pigment used may assist in allowing the NIR reflective layer to be reflective. In one embodiment, at least one pigment used in the NIR reflective layer is rutile titanium dioxide. In some embodiments, substantially no titanium dioxide is used in the NIR reflective layer. In another embodiment, less than 1% by weight of titanium dioxide is used in the NIR reflective layer. In yet another embodiment, less than 0.5% by weight of titanium dioxide is used in the NIR reflective layer. In still another embodiment, less than 0.1% by weight of titanium dioxide is used in the NIR reflective layer. In another embodiment, at least one pigment used in the NIR reflective layer is a black pigment.

### NIR Transmitting Layer (Also Referred to as a Basecoat)

In many embodiments, the NIR transmitting layer means the NIR light can pass through this layer without any absorption or reflection. In other embodiments, NIR transmitting layer means the NIR light can pass through this layer with substantially no absorption or reflection. In some embodiments, NIR transmitting layer means the NIR light can pass through this layer with minimal absorption or reflection. In many embodiments, at least one NIR transmitting layer 220 comprises at least one pigment. The NIR transmitting layer may also be referred to as a basecoat.

In many embodiments, the coatings system 200 may comprise 10% to 50% by weight of at least one pigment. In some embodiments, at least one pigment can, for example, range from about 15% to about 50%, from about 20% to about 40%, from about 25% to about 40%, from about 30% to about 50%, from about 10% to about 40%, from about 10% to about 30%, from about 10% to about 25%, from about 10% to about 20%, from about 20% to about 50%, from about 20% to about 35%, from about 20% to about 30%, from about 25% to about 50%, and from about 25% to about 45%. Other ranges are also contemplated.

In one embodiment, at least one pigment of the NIR transmitting layer is an organic pigment. In another embodiment, at least one pigment of the NIR transmitting layer is an inorganic pigment. For a NIR transmitting layer 220, both organic pigments and inorganic pigments may be used within the same NIR transmitting layer 220. In some embodiments, at least one pigment NIR transmitting layer is an organic pigment. In some embodiments, the organic pigment is perylene black, organic colorants, organic dyes, or combinations thereof. In some embodiments, the organic pigment is phthalocyanine blue, perylene black, isoindolinone yellow, Quinacridone violet, pigment red 254, perylene red, benzimidazole brown, their combinations thereof. In one embodiment, the inorganic pigment is a pigment dispersion. In many embodiments, the coatings system 200 may comprise 1% to 10% by weight of at least one inorganic pigment. In some embodiments, at least one pigment can, for example, range from about 1% to about 9%, from about 2% to about 9%, from about 1% to about 8%, from about 1% to about 7%, from about 2% to about 8%, from about 2% to about 7%, from about 3% to about 9%, from about 3% to about 8%, from about 3% to about 7%, from about 4% to about 9%, from about 4% to about 8%, from about 5% to about 9%, and from about 5% to about 8%. Other ranges are also contemplated.

In some embodiments, at least one pigment of the NIR transmitting layer is an inorganic pigment. In some embodiments, the inorganic pigment is titanium dioxide, zinc oxide, aluminum silicate, magnesium silicate, silica, barium sulfate, calcium sulfate, zinc chromate, chromium hematite/chromium iron oxides, chromium oxide, iron oxide, copper oxide, calcium molybdate, strontium molybdate, zinc molybdate, zinc phosphate, zinc powder, copper powder, aluminum powder, zinc sulfide, cadmium sulfide, pearlized pigments, mica, metallic pigments, metallic effects pigments, china clay, Diatomaceous silica, inorganic colorants, inorganic dyes, or combinations thereof. In one embodiment, the inorganic pigment is a pigment dispersion. In another embodiment, the inorganic pigment is a paste.

In many embodiments, at least one inorganic pigment comprises 10% to 50% by weight of the coatings system 200. In some embodiments, at least one inorganic pigment can, for example, range from about 15% to about 50%, from about 20% to about 40%, from about 25% to about 40%, from about 30% to about 50%, from about 10% to about 40%, from about 10% to about 30%, from about 10% to about 25%, from about 10% to about 20%, from about 20% to about 50%, from about 20% to about 35%, from about 20% to about 30%, from about 25% to about 50%, and from about 25% to about 45%. Other ranges are also contemplated.

In many embodiments, the coating system 200 further comprises at least one clear coat 210 at least partially coating at least one NIR transmitting layer 220. In many embodiments, at least one clear coat 210 is optional. In many embodiments, the clear coat 210 may provide an additional protective layer for improved coating system durability. In many embodiments, the clear coat 210 comprises at least one polymer binder, at least one solvent, and at least one additive for leveling.

In many embodiments, the coating system 200 described herein is a solvent-borne system. In other embodiments, the coatings system 200 described herein is a waterborne system.

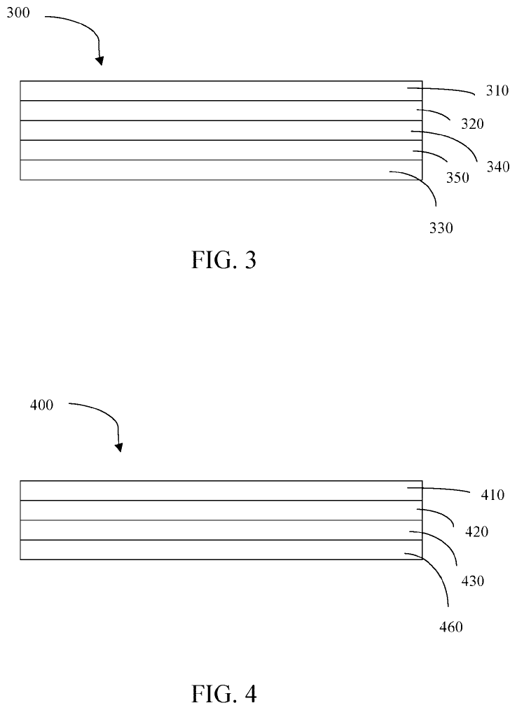

In FIG. 3, multiple NIR transmitting layers 320, 340 and multiple converter layers 330, 350 are shown within the coating system 300 described herein. In particular, the coatings system 300 in FIG. 3 is comprises both an NIR transmitting layer 320 and a second NIR transmitting layer 340. Additionally, the coatings system 300 in FIG. 3 is comprises both a converter layer 330 and a second converter layer 350. As shown in FIG. 3, the coatings system 300 also has an optional clear coat 310 at least partially coating the NIR transmitting layer 320. Although two NIR transmitting layers 320, 340 and two converter layers 330, 350 are shown in FIG. 3, the number NIR transmitting layers and converter layers are not limited as such. Further, it is understood that the coating system described herein (but not shown) may only have one NIR transmitting layer and multiple converter layers as well as multiple transmitting layers and one converter layer. Other configurations are also contemplated.

### Coating System Color

In many embodiments, the coatings system (200, 300) described and shown herein may be provided in a variety of colors. In one embodiment, the coatings system (200, 300) described and shown herein may be black and provide jetness. Jetness of a color is a measure of the darkness of the color. The jetness may be quantified by obtaining color data from a spectrophotometer (for example, GretagMacBeth® Color-Eye® 2145) and using the following formula as discussed in K. Lippok-Lohmer, Farbe+Lack, 92, p. 1024 (1986): Jetness=100* (log₁₀(Xn/X)−log₁₀(Yn/Y)−log₁₀(Zn/Z)). For jetness, the black jetness (Mc) may be in the range of 250 to 300 as provided by ISO 18314-3. Specifically, ISO 18314-3 specifies different methods of calculating special indices, which are generally used to describe lightness respectively jetness of samples including chroma or hue within one color-coordinate. ISO 18314-3 is also applicable to tristimulus values and chromaticity coordinates calculated using color-matching functions of the CIE 1964 standard colorimetric system. It can be used for the specification of color stimuli perceived as belonging to a reflecting or transmitting object, where a one-dimensional value is required. In particular, the jetness may be achieved through the use of the converter layer at least partially coated by the NIR transmitting layer having an L* value ranging from 0 to 80 according to the CIELAB L*a*b* system. As such, the converter layer described herein, acting either as a primer or as a layer coated onto a primer, may provide a darker color underneath the basecoat.

In another embodiment, the coatings system (200, 300) described and shown herein may be transparent. In yet another embodiment, the coatings system (200, 300) described and shown herein may be comprised of colored pigments. The pigments may be organic pigments, inorganic pigments, or combinations thereof.

Further, in many embodiments, the coatings system (200, 300) may provide improved adhesion to various substrates. Further, in many embodiments, the coatings system (200, 300) may provide improved corrosion resistance and chemical resistance.

In many embodiments, the coating system (200, 300) described herein is LiDAR visible, LiDAR visible meaning that the coating system (200, 300) is within the wavelength spectrum to be detected by a LiDAR sensor. In many embodiments, the coating system (200, 300) is detectable by a LiDAR sensor at wavelengths of about 290 nm to about 2050 nm. In other embodiments, the coating system (200, 300) can, for example, range from about 550 nm to about 2050 nm, from about 550 nm to about 1600 nm, from about 600 nm to about 1600 nm, from about 650 nm to about 1600 nm, from about 700 nm to about 1600 nm, from about 750 nm to about 1600 nm, from about 800 nm to about 1600 nm, from about 850 nm to about 1600 nm, and from about 900 nm to about 1600 nm. Other ranges are also contemplated. Further the coating system (200, 300) can be detectable at a single specific wavelength. In one embodiment, the coating system (200, 300) is detectable by a LiDAR sensor at a wavelength of about 903 nm. In one embodiment, the coating system (200, 300) is detectable by a LiDAR sensor at a wavelength of about 905 nm. In one embodiment, the coating system (200, 300) is detectable by a LiDAR sensor at a wavelength of about 1540 nm. In one embodiment, the coating system (200, 300) is detectable by a LiDAR sensor at a wavelength of about 1550 nm. In one embodiment, the coating system (200, 300) is detectable by a LIDAR sensor at a wavelength of about 1560 nm. Other specific wavelengths are also contemplated.

In FIG. 4, the article 400 comprises the coatings system described herein which has been applied to a substrate 460. In some embodiments, the substrate may be chemically treated prior to applying the coatings system described herein. In some embodiments, an electro-deposition coating may be applied directly to the substrate or a substrate that has been chemically treated. In many embodiments, the coating system described herein is at least partially coated on a substrate 460. In many embodiments, the substrate 460 is plastic, metal, wood, glass, concrete, cement, paper, leather, ceramic, fabric, composite, or combinations thereof. In one embodiment, the substrate is a non NIR-reflective substrate. The coating system comprises at least one converter layer 430 and at least one NIR transmitting layer 420 at least partially coating the at least one converter layer 430. In many embodiments, at least one converter layer 430 is an NIR reflective layer. The article 400 may comprise: 1) a substrate 460 having at least one surface; and 2) the coating system described herein at least partially coated on the at least one surface of the substrate 460. In many embodiments, the substrate 460 comprises wood, metal, glass, plastic, paper, leather, fabric, ceramic, composite, or any combination thereof. Other substrates are also contemplated. In some embodiments, the article 400 may also comprise a clear coat 410 at least partially coated on at least one NIR transmitting layer 420.

In another embodiment, the substrate is pretreated. In some embodiments, the substrate is pretreated with a sol-gel type for aluminum. In other embodiments, the substrate is pretreated with an adhesion promoter for plastic. In yet other embodiments, the substrate is pretreated with a phosphoric acid or chrome conversion pretreatment for corrosion resistance. In some embodiments, the substrate may be pretreated more than once. In other embodiments, the substrate may undergo more than one type of pretreatment. In some embodiments, the pretreatment may be also done in combination with an e-coating.

In yet another embodiment, the substrate is e-coated. E-Coating, also known as electrodeposition coating, electropainting, electrocoating, is a method of coating a surface using electrical current in which electrically charged particles are deposited out of a water suspension to coat a substrate. In some embodiments, the e-coating may be also done in combination with a pretreatment.

### Method of Preparing the Coating System

Also disclosed is a method of preparing the coating system disclosed herein. The coating system comprises at least one converter layer and at least one NIR transmitting layer at least partially coating the at least one converter layer, wherein the converter layer at least partially coated by the NIR transmitting layer has an L* value ranging from 0 to 80 according to the CIELAB L*a*b* system. In many embodiments, at least one converter layer is an NIR reflective layer.

Article with the Coating System

Also disclosed is an article with the coating system described herein. The coating system comprises at least one converter layer and at least one NIR transmitting layer at least partially coating the at least one converter layer, wherein the converter layer at least partially coated by the NIR transmitting layer has an L* value ranging from 0 to 80 according to the CIELAB L*a*b* system. In many embodiments, at least one converter layer is an NIR reflective layer.

The article is comprised of a substrate, and the substrate may plastic, metal, wood, glass, concrete, cement, paper, leather, ceramic, fabric, composite, or combinations thereof. The coatings system described herein may be at least partially applied to the article.

### EXAMPLES

Table 1 below provides performance testing results for the coatings system described herein on an e-coated substrate. The results provided are the NIR Reflective in % for both Table 1 and Table 2 using a spectrophotometric method that uses the near-infrared region of the electromagnetic spectrum. The reflectance may be calculated by comparing the amount of reflected radiation to the amount of incident radiation. For the reflectance measured in all testing provided herein, ISO 15368:2021 was used. The various wavelengths used in testing reflectance are provided in the tables below.

Specifically in Tables 1 and 2, the samples were measured by a spectrophotometer that allows for analysis of materials using UV, Visible, and near-infrared light in transmission and reflection modes. A 150 mm sphere accessory was used for testing. Samples were evaluated from 250 nm to 2500 nm in 5 nm steps. For Table 1, an e-coated substrate was used. During e-coating, a substrate undergoes an immersion wet paint finishing process that uses electrical current to attract the paint product to a metal surface. The results provided are the NIR Reflective in % at both 905 nm and 1550 nm.

TABLE 1
Reflectivity Testing Results on an E-Coated Substrate

| | 905 | 1550 |
|---|---|---|
| Sample | nm | nm |
| E-coated Non NIR Reflective Substrate | 16.95 | 28.15 |
| converter layer (primer) | 80.01 | 56.45 |
| converter layer (primer) and NIR- | 78.19 | 57.13 |
| transmitting layer (basecoat) | | |
| converter layer (primer) + NIR- | 76.70 | 54.16 |
| transmitting layer (color | | |
| basecoat) + clear coat | | |

Based on the results in Table 1, the NIR reflectance using a coating with the converter layer on an e-coated non NIR-reflective substrate provides improved performance over an e-coated non NIR-reflective substrate without the converter layer of the coatings system described herein. Further the addition of a basecoat, either with or without a clear coat, provides similar results to the converter layer alone.

Specifically in Table 2 below, performance testing results are provided for the coatings system described herein on a plastic substrate. The results provided are the NIR Reflective in % at both 905 nm and 1550 nm.

TABLE 2
Reflectivity Testing Results on Plastic

| | 905 | 1550 |
|---|---|---|
| Sample | nm | nm |
| plastic non NIR reflective substrate | 11.32 | 10.70 |
| converter layer (primer) | 82.81 | 63.21 |
| converter layer (primer) and NIR- | 79.00 | 62.00 |
| transmitting layer (color basecoat) | | |
| converter layer (primer) + NIR- | 77.81 | 59.18 |
| transmitting layer (color | | |
| basecoat) + clear coat | | |

For Table 2, the NIR reflectance using a coating with the converter layer on a plastic substrate provides improved performance over a plastic substrate without the converter layer of the coatings system described herein. Further the addition of a NIR-transmitting layer (basecoat), either with or without a clear coat, provides similar results to the converter layer alone.

For Table 3, a primer coating with only non-NIR-reflective dark-colored or black pigments (provided as Control C) was completely replaced with NIR-reflective metal oxide pigments. The other samples used the primer formula but replaced the titanium dioxide with another pigment. In many examples, the pigments were black pigments. From the data, replacing the titanium dioxide with various metal oxide pigments may provide an increased NIR reflectivity for the coating. Reflectivity was measured at both 905 nm and 1550 nm.

TABLE 3
Primer Reflectivity Testing of Titanium Dioxide
Replacement with Dark or Black Pigments

| | Reflectivity % | |
|---|---|---|
| Sample | 1550 nm | 905 nm |
| Control C (carbon black only) black primer | 4.59 | 4.97 |
| Chromium iron oxide pigment A (no TiO2) | 59.33 | 14.85 |
| Chromium iron oxide pigment B (no TiO2) | 19.37 | 18.19 |
| Copper oxide pigment (no TiO2) | 68.77 | 19.15 |
| Chromium oxide pigment A (no TiO2) | 65.68 | 21.34 |
| Chromium oxide pigment B (no TiO2) | 72.70 | 19.78 |
| Chromium oxide pigment C (no TiO2) | 71.96 | 21.09 |

In Table 4 below, the reflectivity testing was similar to the titanium dioxide replacement with dark or black pigments. The chromium oxide sample used the Control A primer formula but replaced the titanium dioxide with chromium oxide. For Table 4, the titanium dioxide primer (provided as Control A) was blended with non-NIR-reflective pigments, namely carbon black. Various ratios are provided. From the data, replacing the titanium dioxide with NIR-reflective chromium oxide pigments may provide an NIR reflectivity for the coating. Reflectivity was measured at both 905 nm and 1550 nm.

TABLE 4
Reflectivity Testing of Titanium Dioxide Replacement
with Dark or Black Pigments Provided in a Gray Primer

Reflectivity %

| Sample | 1550 nm | 905 nm |
|---|---|---|
| Control A (TiO2 only) - white primer | 65.96 | 84.44 |
| Control B (no TiO2) - black primer | 13.18 | 23.44 |
| containing carbon black | | |
| 90% Control A, 10% Control B | 66.63 | 58.21 |
| 80% Control A, 20% Control B | 66.80 | 47.82 |
| 60% Control A, 40% Control B | 68.94 | 35.97 |
| Chromium oxide pigment C (no TiO2) | 71.96 | 21.09 |

In Table 5 below, the thickness of the coating may directly affect the NIR-reflectivity. In particular, both samples (Control A and the test sample replacing titanium dioxide with chromium oxide) showed increased reflectivity readings when the thickness of the coating increased.

TABLE 5
Effect of Film Thickness on NIR-Reflectivity

| | |
|---|---|
| Thickness | Reflectivity % |

| Sample | (in μm) | 1550 nm | 905 nm |
|---|---|---|---|
| Control A (TiO2 only) - | 100 | 48.48 | 67.87 |
| white primer | | | |
| Control A (TiO2 only) - | 200 | 60.13 | 80.28 |
| white primer | | | |
| Chromium oxide pigment | 100 | 55.73 | 21.69 |
| C (no TiO2) | | | |
| Chromium oxide pigment | 200 | 69.00 | 21.96 |
| C (no TiO2) | | | |

In Table 6, varying approaches to providing a black or gray shade primer were compared to a typical black primer prepared with carbon black (referred to as Control B). While the use of metal oxides in the results above may provide NIR-reflective coatings, there are certain materials that reduce or eliminate any NIR-reflective properties. An example of a non-NIR-reflective material is carbon black. By replacing the carbon black with NIR-reflective pigments like chromium oxide, the reflectivity may be significantly increased.

TABLE 6
Effect of non-NIR-Reflective Materials in
a Primer vs. an NIR-Reflective Basecoat

Reflectivity %

| Sample | 1550 nm | 905 nm |
|---|---|---|
| Control B black primer | 5.26 | 5.04 |
| with carbon black | | |
| Control A white primer removing | 72.32 | 31.3 |
| TiO2 and replacing with | | |
| chromium oxide pigment C | | |
| Control C black primer + | 65.89 | 32.78 |
| chromium oxide pigment C | | |

### Embodiments

The following embodiments are contemplated. All combinations of features and embodiments are contemplated.

Embodiment 1: A coating system comprising: at least one converter layer and at least one NIR transmitting layer at least partially coating the at least one converter layer, wherein the converter layer at least partially coated by the NIR transmitting layer has an L* value ranging from 0 to 80 according to the CIELAB L*a*b* system.

Embodiment 2: An embodiment of Embodiment 1, wherein at least one converter layer is an NIR reflective layer.

Embodiment 3: An embodiment of any of Embodiments 1-2, wherein the NIR reflective layer comprises at least one pigment.

Embodiment 4: An embodiment of any of Embodiments 1-3, wherein at least one NIR transmitting layer comprises at least one pigment.

Embodiment 5: An embodiment of Embodiment 4, wherein at least one pigment is an organic pigment.

Embodiment 6: An embodiment of Embodiment 4, wherein at least one pigment is an inorganic pigment.

Embodiment 7: An embodiment of any of Embodiments 1-6, wherein at least one converter layer is a primer.

Embodiment 8: An embodiment of any of Embodiments 1-7, wherein the coating system further comprises at least one clear coat at least partially coating at least one NIR transmitting layer.

Embodiment 9: An embodiment of any of Embodiments 1-8, wherein the coating system is a LiDAR visible.

Embodiment 10: An embodiment of any of Embodiments 1-9, wherein the coating system is detectable by a LiDAR sensor at wavelengths of about 290 nm to about 2050 nm.

Embodiment 11: An embodiment of any of Embodiments 1-9, wherein the coating system is detectable by a LiDAR sensor at wavelengths of about 550 nm to about 1600 nm.

Embodiment 12: An embodiment of any of Embodiments 1-9, wherein the coating system is detectable by a LiDAR sensor at wavelengths of about 750 nm to about 1600 nm.

Embodiment 13: An embodiment of any of Embodiments 1-12, wherein the coating system is at least partially coated on a substrate.

Embodiment 14: An embodiment of Embodiment 13, wherein the substrate is plastic, metal, wood, glass, concrete, cement, paper, leather, ceramic, fabric, composite, or combinations thereof.

Embodiment 15: An embodiment of any of Embodiments 13-14, wherein the substrate is a non NIR-reflective substrate.

Embodiment 16: An embodiment of any of Embodiments 13-14, wherein the substrate is pretreated.

Embodiment 17: An embodiment of any of Embodiments 13-14, wherein the substrate is e-coated.

Embodiment 18: A method of preparing the coating system of any of Embodiments 1-17. Embodiment 19: An article with the coating system of any of Embodiments 1-17.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A coating system comprising:
at least one converter layer; and
at least one NIR transmitting layer at least partially coating the at least one converter layer;
wherein the converter layer at least partially coated by the NIR transmitting layer has an L* value ranging from 0 to 80 according to the CIELAB L*a*b* system.

2. The coating system of claim 1, wherein at least one converter layer is an NIR reflective layer.

3. The coating system of claim 1, wherein the NIR reflective layer comprises at least one pigment.

4. The coating system of claim 1, wherein at least one NIR transmitting layer comprises at least one pigment.

5. The coating system of claim 4, wherein at least one pigment is an organic pigment.

6. The coating system of claim 4, wherein at least one pigment is an inorganic pigment.

7. The coating system of claim 1, wherein at least one converter layer is a primer.

8. The coating system of claim 1, wherein the coating system further comprises at least one clear coat at least partially coating at least one NIR transmitting layer.

9. The coating system of claim 1, wherein the coating system is a LiDAR visible.

10. The coating system of claim 1, wherein the coating system is detectable by a LiDAR sensor at wavelengths of about 290 nm to about 2050 nm.

11. The coating system of claim 1, wherein the coating system is detectable by a LiDAR sensor at wavelengths of about 550 nm to about 1600 nm.

12. The coating system of claim 1, wherein the coating system is detectable by a LiDAR sensor at wavelengths of about 750 nm to about 1600 nm.

13. The coating system of claim 1, wherein the coating system is at least partially coated on a substrate.

14. The coating system of claim 13, wherein the substrate is plastic, metal, wood, glass, concrete, cement, paper, leather, ceramic, fabric, composite, or combinations thereof.

15. The coating system of claim 13, wherein the substrate is a non NIR-reflective substrate.

16. The coating system of claim 13, wherein the substrate is pretreated.

17. The coating system of claim 13, wherein the substrate is e-coated.

18. A method of preparing the coating system of claim 1.

19. An article with the coating system of claim 1.
